(19) United States
(12) Patent Application Publication
(10) Pub. No.: US 2023/0211719 A1
(43) Pub. Date: Jul. 6, 2023

(54) WINCH FOR FLATBED TRUCKS THAT IS DESIGNED TO BE TIGHTENED WITH A STANDARD TORQUE WRENCH

(71) Applicants: Prabhav Agarwalla, Solon, OH (US); Vibhav Agarwalla, Solon, OH (US)

(72) Inventors: Prabhav Agarwalla, Solon, OH (US); Vibhav Agarwalla, Solon, OH (US)

(21) Appl. No.: 17/646,516

(22) Filed: Dec. 30, 2021

(51) Int. Cl. B60P 7/08

(52) U.S. Cl. CPC B60P 7/0853

(57) ABSTRACT

A winch socket driver interface is provided for winding and unwinding a cargo winch when strapping cargo. The socket driver interface may include a receiving socket dimensioned and adapted for operatively associating with a standard torque wrench driver or other socket-driven tools for rotating the rotation bar of the cargo winch, thereby enabling the selective tightening and loosening of cargo straps.

### BACKGROUND OF THE INVENTION

The present invention relates to cargo winches and, more particularly, a winch for flatbed trucks, wherein the winch provides a socket driver interface designed to be tightened with a standard torque wrench.

Tightening a standard flatbed trailer winch with a standard winch bar requires significant force and time to tighten, and thus is a laborious and time-consuming task that can also lead to injury if not done properly. It can be taxing on the body to continually use a winch bar to tighten a winch. A standard or ratcheting winch bar is also a tool specifically sold for the flatbed industry, and so can be hard to find when on the road in a pinch.

Moreover, when using a winch bar there is no precise method for setting a precise amount of torque, so it is mostly guesswork. This inability to regulate the amount of torque being translated to the cargo strapping and lack of precision tends to create accidents and damage. For instance, on high value, high risk cargo, the straps are under-torqued of if the straps are over torqued can lead to strapped items shifting in transport or to the straps crushing the cargo, respectively. Over torquing can also cause personal injury.

In sum, current methods require too much time and effort to use. Their simple design does not allow for efficiency when tightening the winch. Additionally, current solutions do not allow for precise torque input, and standard winch bars are seldom found in typical consumer stores flatbed truckers may frequent to when on the road.

As can be seen, there is a need for a winch for flatbed trucks that is designed to be tightened with a standard torque wrench, which can be easily found in general stores across the country.

The design of the winch embodied in the present invention can be tightened with less force and in less time than a standard winch. It also enables for the selectively application of precise amounts of torque to be used. Additionally, it opens the door for the implementation of other technologies to integrate with the socket driver interface of the present invention; for instance, pressurized air systems. Likewise, the socket driver interface of the winch also would allow for torque sensors to be implemented to continuously monitor the torque amount on each strap.

In sum, the present invention allows a user to use a standard ratcheting torque wrench to tighten the cargo winch strapping, thereby requiring less force than a standard winch bar due to the mechanical efficiency of a torque wrench, making it safer and less labor intensive. The present invention further enables the use of a torque wrench with precision calibration for the tightness of the straps. Furthermore, the socket driver interface also allows for re-spooling the strap much faster using a socket-driving rewinding tool.

### SUMMARY OF THE INVENTION

In one aspect of the present invention, a method of increasing the efficiency of a cargo winch, the method includes: providing a socket-driven interface rotatably coupled to a rotation bar of the cargo winch, wherein the socket-driven interface includes a receiving socket, wherein the socket-driven interface includes a drive socket providing the receiving socket, wherein the socket-driven interface includes a drive face set back from the drive socket, wherein the socket-driven interface is disposed along a distal end of a collar rotatably coupled to the rotation bar, wherein the collar has a plurality of circumferentially-disposed winch bar openings, wherein the plurality of winch bar openings and the receiving socket communicate to a shared void 48 housed by the collar.

In another aspect of the present invention, a cargo winch includes the following: a rotation bar; a collar rotatably coupled to the rotation bar; a socket-driven interface disposed along a distal end of the collar, the socket-driven interface providing: a receiving socket; a drive socket providing the receiving socket; and a drive face set back from the drive socket, wherein the collar has a plurality of circumferentially-disposed winch bar openings, wherein the plurality of winch bar openings and the receiving socket communicate to a shared void 48 housed by the collar.

These and other features, aspects and advantages of the present invention will become better understood with reference to the following drawings, description and claims.

### BRIEF DESCRIPTION OF THE DRAWINGS

FIG. 1 is a top right perspective view of an exemplary embodiment of the present invention, shown in use.

FIG. 2 is a top right perspective view of an exemplary embodiment of the present invention.

FIG. 3 is an exploded top right perspective view of an exemplary embodiment of the present invention.

FIG. 4 is a top left perspective view of an exemplary embodiment of the present invention.

FIG. 5 is a section view of an exemplary embodiment of the present invention, taken along line 5-5 in FIG. 2.

FIG. 6 is an exploded top left perspective view of an alternative exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a winch socket driver interface for winding and unwinding a cargo winch when strapping cargo. The socket driver interface may include a receiving socket dimensioned and adapted for operatively associating with a standard torque wrench driver for rotating the rotation bar of the cargo winch.

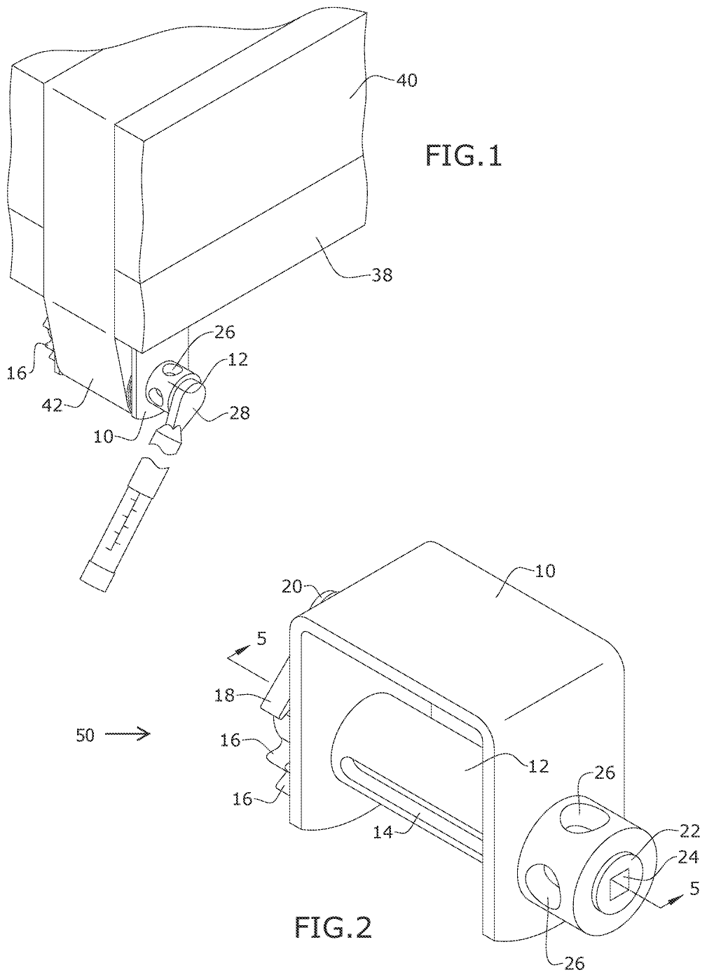

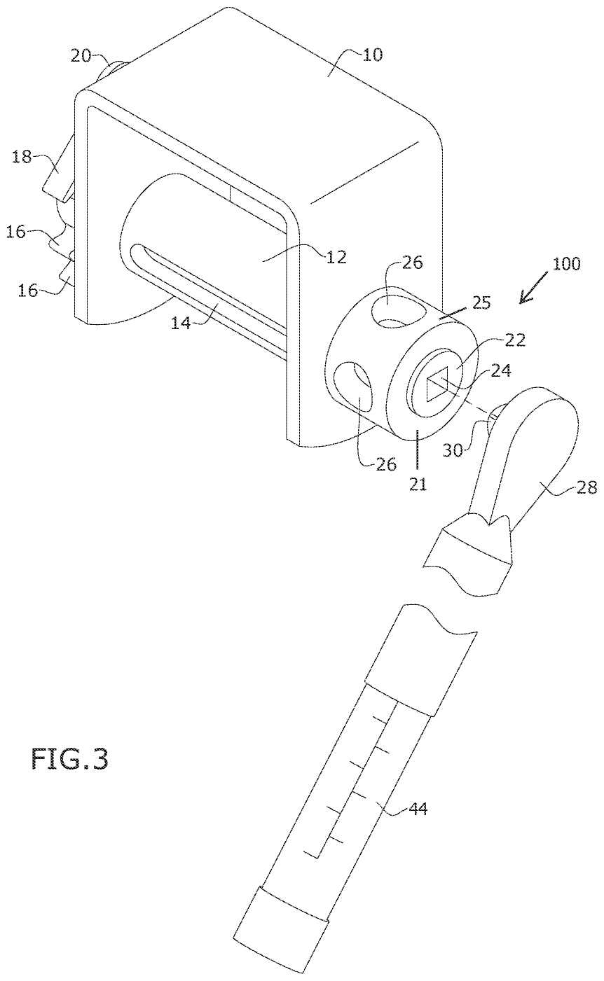

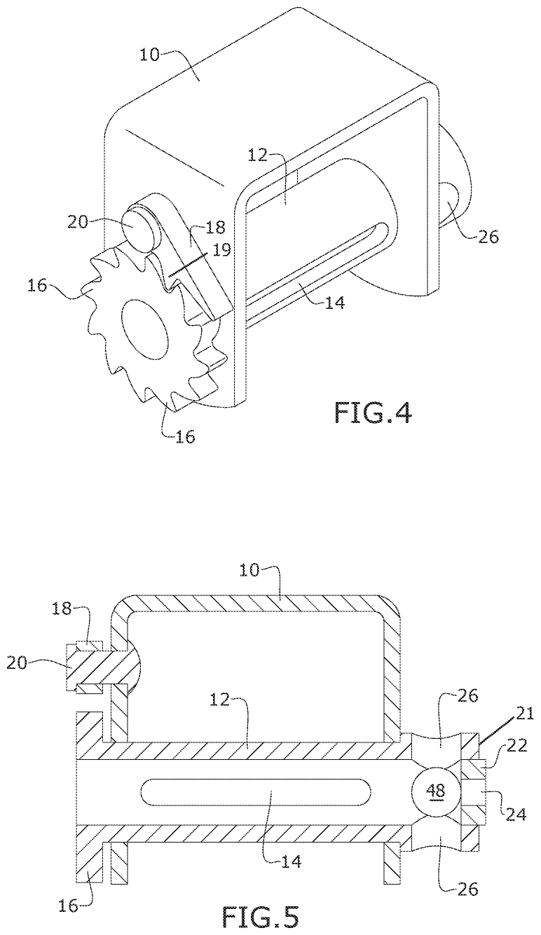

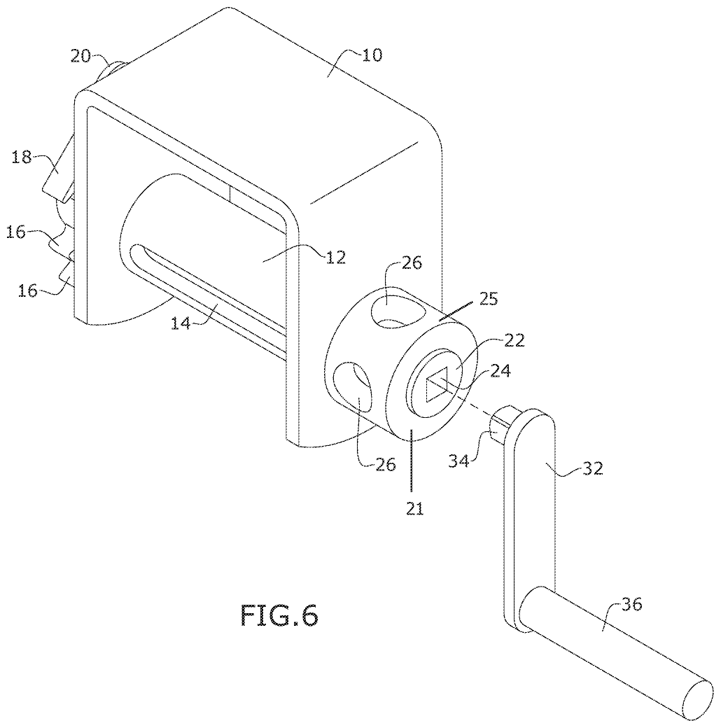

Referring now to FIGS. 1 through 6, the present invention may include a cargo winch 50 having a U-shaped channel 10 mounted to an object 38, such as a truck bed or the like. Channel 10 rotatably engages rotation bar 12 with a strap opening 14 formed therein. A sprocket gear 16 on one side of the channel 10 enables the rotation bar 12 (in the industry this may be referred to as the mandrel) to rotate in a first rotational direction (e.g., counter-clockwise) but not the opposite direction (clockwise) unless a pawl 18 is lifted by way of a pivot pin 20 to clear pawl tooth 19 from an enmeshed tooth of the sprocket gear 16.

Opposite the sprocket gear 16 is a collar 25 having at least two winch bar openings 26 formed therein. The collar 25 is operatively associated with the rotation bar 12 for rotating it in either the first or second rotational directions. A distal end of the collar 25 provides a drive face 21 including a drive socket 22 having a receiving socket 24 dimensioned and adapted to operatively associate with a socket driver 30 or 34 of a wrench 28 or (re-)spooling tool 32, respectively, to be used to adjust the winch 50, to tighten or loosen the winch 50. The drive socket 22 may be set forward from the drive face 21 to facilitate engagement of a socket-driver tool to the receiving socket 24. It should be understood that the precise mechanism of engagement between socket-driver tool may vary. Any type of adaptor can be used as an intermediary to connect the socket driver tool with the winch 50.

Furthermore, the receiving socket 24 facilitates any socket-based tool that supplies the mechanical advantage, if any, desired by the user to provide the torque needed to operate the winch 50 so that a strap 42 engaged in the strap opening 14 can be wound onto or unwound from the rotation bar 12 by rotating it in the first or second rotational direction.

The torque wrench 28 may provide ratcheting and a click when a preset torque is reached. Once that final tension is reached, the torque wrench 28 will begin chirping and notify the user—i.e., until the torque wrench chirps, the user knows they must keep tightening. Other types of torque wrenches may be employed, such as ones with torque limiting functionality allowing a preset torque to be reached before they slip. Some torque wrenches 28 may have digital read-outs 44 of torque. As a result, the torque wrenches 28 can be set to a desired final tension in advance.

In short, the user gets the ability to selectively achieve an exact, pre-determined level of tension in the strap 42, which the user prefers for the specific cargo 40 being secured. This aspect of the winch 50 embodied in the present is vastly different than industry standard winches which require a winch bar to in essence guess the appropriate tighten and final tension.

After the strap tension has been released a re-spooling tool 32 fits into the receiving socket 24 and allows a user to (by way of the handle 36 of the spooling tool 32) re-spool the winch strap 42 neatly for storage. The combination of these two innovations translates to less time rigging cargo 40 for flatbed truckers 38 and more time delivering essential supplies on America's roadways.

In one embodiment, a 0.5″ receiving socket 24 allows for the use of a standard sized torque wrench 28 to be used to adjust tightness of the winch 50. The rewinding/spooling tool 32 can be used after the strap 42 has been loosened to re-spool it much faster. Both tools used together can significantly decrease the amount of time and labor spent tightening winch straps 42 on a flatbed truck 38.

A method of using the present invention may include the following. The winch 50 disclosed above may be provided. The present invention allows a flatbed trucker or any other person to tighten straps 42 fed through the winch 50 using a torque wrench 28 placed into the receiving socket 24 tighten or loosen the winch 50 using the torque wrench 28. In the future this concept could be used for higher end methods of adjusting the flatbed winch 50.

This simple socket interface opens the door for electronic adjustment. For example, an electric drill may work very well with the winch 50 if the rotational direction of the drill is coaxial with the rotational direction of the rotation bar 12. They would work very well with this because of co-axiality and no alteration of drill torque through gears. This is different from prior art instances where a work gear is used to alter torque direction. Separately, there are electric drills that measure and display torque, which is another functionality the present invention enables for the cargo winch 50.

In certain embodiments, the torque wrench 28 can be set to desired final tension in advance. Once that final tension is reached, the torque wrench will begin chirping and notify the user. Until the torque wrench chirps, the user knows they must keep tightening. Other torque wrenches sold in the market help users achieve the precisely desired tension in other ways, but the result is the same. The user gets the ability to achieve an exact, pre-determined level of tension, as opposed to the prior art ‘gut feel’ they are relying on by simply slapping the strap hard. In the future this concept could be used for higher end methods of adjusting the flatbed winch.

Additionally, the winch embodied in the present invention has the potential to be used in a variety of ways. Currently it is designed to be used by inserting a torque wrench. However, in the future it could have a built-in wrench that could be powered by an electronic source. Additionally, it could also be connected to a flatbed trucks ABS system. This would allow the winch to be tightened from a mechanism within the truck's cab. This allows for drivers to adjust winch tightness on the fly, preventing accidents. Moreover, while the disclosure focuses on the flatbed winch market, the inventive concept could potential for other winches in other industries as well.

The present invention may be created by cutting a square through the turning mechanism on the winch. The square acts as a receiving socket. A standard torque wrench can then be inserted into the socket to adjust the winch. The torque wrench turns the winch, tightening the winch strap on the winch. The receiving socket is the crucial component that differentiates our companies new winch from previous flatbed winches without this socket. The re-spooling tool is not necessary to the function of the socket but is an important addition. The socket-driven interface 100 enables the new technologies to be incorporated down the road; for example, a standard torque wrench could be swapped out for an electronic motor or compressed air to tighten the winch.

As used in this application, the term “about” or “approximately” refers to a range of values within plus or minus 10% of the specified number. And the term “substantially” refers to up to 90% or more of an entirety. The words “about,” “approximately,” or the like, when accompanying a numerical value, are to be construed as indicating a deviation as would be appreciated by one of ordinary skill in the art to operate satisfactorily for an intended purpose.

Recitation of ranges of values herein are not intended to be limiting, referring instead individually to any and all values falling within the range, unless otherwise indicated, and each separate value within such a range is incorporated into the specification as if it were individually recited herein.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A method of increasing the efficiency of a cargo winch, the method comprising:
providing a socket-driven interface rotatably coupled to a rotation bar of the cargo winch.

2. The method of claim 1, wherein the socket-driven interface includes a receiving socket.

3. The method of claim 2, wherein the socket-driven interface includes a drive socket providing the receiving socket.

4. The method of claim 3, wherein the socket-driven interface includes a drive face set back from the drive socket.

5. The method of claim 4, wherein the socket-driven interface is disposed along a distal end of a collar rotatably coupled to the rotation bar.

6. The method of claim 5, wherein the collar has a plurality of circumferentially-disposed winch bar openings.

7. The method of claim 6, wherein the plurality of winch bar openings and the receiving socket communicate to a shared void housed by the collar.

8. A cargo winch comprising:
a rotation bar;
a collar rotatably coupled to the rotation bar; and
a socket-driven interface disposed along a distal end of the collar, the socket-driven interface comprising:
a receiving socket;
a drive socket providing the receiving socket; and
a drive face set back from the drive socket.

9. The cargo winch of claim 8, wherein the collar has a plurality of circumferentially-disposed winch bar openings.

10. The cargo winch of claim 9, wherein the plurality of winch bar openings and the receiving socket communicate to a shared void housed by the collar.
